(19) United States
(12) Patent Application Publication
(10) Pub. No.: US 2012/0179589 A1
(43) Pub. Date: Jul. 12, 2012

(54) METHOD OF IDENTIFYING A MORTGAGE INTEREST RATE

(75) Inventors: Veeraraj MAHALINGAM, Frisco, TX (US); Gary L. GRIFFIN, Frisco, TX (US)

(73) Assignee: BANK OF AMERICA CORPORATION, Charlotte, NC (US)

(21) Appl. No.: 13/110,626

(22) Filed: May 18, 2011

Related U.S. Application Data
(60) Provisional application No. 61/430,737, filed on Jan. 7, 2011.

(51) Int. Cl. G06Q 40/00

(52) U.S. Cl. 705/35

(57) ABSTRACT

A method of identifying a mortgage interest rate is provided that allows a user to identify, using a computing device processor, a more precise interest rate for a mortgage given limited information. In an embodiment, the method allows the user to identify the interest rate given only the original balance, the loan term, and two consecutive balances. The method provides for iterative comparisons between principle and interest (PAI) amounts calculated using different methods. When the two PAI amounts are about equal, the interest rate used to calculate both PAI amounts is the interest rate of the mortgage. The method utilizes constants derived based on the PAI amount to amortize a predetermined amount, such as $1, over the loan term of the mortgage. A method of offering refinancing using the interest rates determined by the method is also provided.

### CLAIM OF PRIORITY UNDER 35 U.S.C. §119

The present application for patent claims priority to Provisional Application No. 61/430,737 entitled “METHOD OF IDENTIFYING A MORTGAGE INTEREST RATE” filed Jan. 7, 2011, and assigned to the assignee hereof and hereby expressly incorporated by reference herein.

### BACKGROUND

People desire to save money on their fixed rate mortgage by refinancing when current mortgage rates are lower than their existing interest rate. Often, however, people do not know the current mortgages rates—or how much money they could be saving by refinancing their mortgage to a lower interest rate.

Financial institutions desire to assist current customers that have a mortgage with a different institution and acquire new customers by providing information on refinancing opportunities. Financial institutions, however, do not have all of the information relating to the user's mortgage. Typically, the financial institution receives mortgage information for a mortgage holder from a credit bureau. The credit bureaus report the original balance on the mortgage, the remaining principle amounts after each payment, the loan term, the required payment, the actual payment made and whether the mortgage holder has been delinquent in paying. In some cases, the total payment is only the principle and interest amount due on the mortgage. In many cases, however, the total payment includes escrow funds, such as taxes and interest. The credit bureaus do not provide a means to determine whether escrow funds are included in the total payment. Thus, a standard equation listed below as Equation 1 cannot be used to determine a mortgage interest rate with confidence based on the total payment because the total payment may include escrow funds. The standard equation, Equation 1, relies on the principle and interest (PAI) amount and two consecutive principle amounts x and y to determine the interest rate.

Interest Rate=((PAI−(principle x−principle y))*12)/principle x Equation 1

If the total payment received from the credit bureau includes escrow funds, then the interest rate calculated using Equation 1 will be inaccurate. Further, as no information relating to whether escrow funds are included in the total payment is provided, the user of Equation 1 would not know when the interest rates calculated using Equation 1 are correct and when they are inaccurate.

The problem associated with Equation 1 has been addressed by solving for PAI using three consecutive principle amounts: x, y, and z, but this approach also has limitations. Equation 2 allows a person to solve for the PAI amount but requires that the consecutive principle amounts be provided down to the nearest cent.

PAI=(principle x*principle z)−(principle y)²)/principle y−principle x Equation 2

If principle amounts accurate to the nearest cent are not used, Equation 2 provides a dramatically incorrect PAI amount. If this incorrect PAI amount is inserted into Equation 1, the interest rate determined from Equation 1 will also be incorrect. The credit bureaus report principle amounts rounded to the nearest dollar and hence Equation 2 does not resolve the problem of calculating interest rates based on information received from the credit bureaus.

When determining whether a mortgage holder could save money by refinancing a mortgage, a more precise interest rate is beneficial because precise calculations can be made with it. In the past, interest rates for mortgages were modeled based on the age of the mortgage, the size of the mortgage, or other demographic information associated with the mortgage holder or the mortgage. These models did not provide the exact interest rate, but instead determined with varying levels of success what the interest rate might be given the rates available at the time the mortgage originated. All of these issues can add up to wasted time, effort, and expense for mortgage holders as they consider refinancing options. Furthermore, the inefficient marketing of refinancing options increases cost to the mortgage provider.

Thus, there is a need for improved systems and methods for identifying mortgage interest rates that is both accurate and effective given limited information.

### BRIEF SUMMARY

Embodiments of the present invention address the above needs and/or achieve other advantages by providing an apparatus (e.g., a system, computer program product, and/or other device) and a computer-implemented method for determining an interest rate for a mortgage loan. In some embodiments of the invention the computer-implemented method can determine the interest rate for the mortgage from information received from a credit bureau.

In contrast to assumptions based on imprecise models, having a more precise interest rate allows the mortgage provider to solicit potential refinancers with precision. The mortgage provider can provide a mortgage holder with a more precise amount that the user would save if they refinanced. This targeted marketing of refinancing is both beneficial to the mortgage holders and effective in marketing refinancing packages. When an accurate indication of savings is provided in an offer for refinancing, significant increases in response to the offer can result. For example, if the savings due to refinancing is not known, the offers to refinance typically receive a 0.25% to 0.5% response rate. If, however, an accurate indication of savings is known the offers to refinance can receive between a 1.0% and 1.5% response rate. The increased efficacy of targeted marketing also saves money for the mortgage provider by not soliciting mortgage holders that would be unlikely to refinance.

For example, some embodiments of the present invention provide a computer-implemented method of determining the interest rate after receiving the original balance, the loan term, and two consecutive principle balances. In one embodiment, the consecutive principle balances are consecutive remaining principle balances after payments have been made on a mortgage. In another embodiment, the consecutive principle balances are the original balance and the principle amount remaining after the first payment. The loan term is used to calculate a constant equal to the principle and interest (PAI) payment to amortize a predetermined amount, such as $1, over the loan term and at a given interest rate. In some embodiments, the PAI payments to amortize the predetermined amount over a plurality of loan terms and interest rates are predetermined and provided in a table of constants. Given this information, the computer-implemented method determines the interest rate with precision.

Equation 3 illustrates how the computer-implemented method uses the original balance, the constant, the consecutive principle amounts, and a plurality of interest rates to determine a more precise interest rate. The method includes iterating through the equation until the product on the left hand side of the equation equals the sum on the right hand side of the equation. The interest rate is converted from the annual percentage interest rate typically provided for a mortgage, such as 5%, into a decimal interest rate for the payment period, such as 5%/(12*100) for a monthly payment period.

iterate through interest rates until: (original balance*constant)=(principle y−principle x)+(principle x*interest rate) Equation 3

When the product on the left hand side of Equation 3 is about equal to the sum on the right hand side of the equation, the interest rate used to produce that result is the interest rate of the mortgage. In one embodiment, about equal means equal when rounded to the nearest dollar. In another embodiment, about equal means the closest after all of the standard interest rates for mortgages at the provided loan term have been considered.

In an embodiment, the computer-implemented method receives loan information, including the original balance, the loan term, the first remaining balance, and the second remaining balance, wherein the first and second remaining balance are consecutive. The computer-implemented method determines a first PAI amount based on the original balance and the constant, and determining a second PAI amount based on the first principle, the second principle, and the interest rate. The computer-implemented method then compares the first PAI amount and the second PAI amount to determine if they are about equal and identifying the interest rate where the first PAI amount and second PAI are about equal. The computer-implemented method identifies the interest rate for a mortgage loan given limited information, such as the information provided by a credit bureau.

In another embodiment of the invention, a computer-implemented method of offering mortgage refinancing uses the interest rate determination to target mortgage holders that are appropriate refinancers. The computer-implemented method identifies a user having a mortgage, receives information pertaining to the user's mortgage, determines the interest rate on the mortgage, determines whether the mortgage holder would save money if the mortgage holder refinanced, and offers refinancing to the mortgage holder. In an embodiment, the computer-implemented method determines the amount that the mortgage holder would realize if the mortgage was refinanced and provides that information in the offer. For example, the mortgage holder may realize monthly payment savings or total life time interest paid savings by reducing the principle and interest payment for the mortgage when refinancing to a lower interest rate.

While the invention has been described herein in terms of computer-implemented methods, a computer program product for providing a mortgage refinancing product is provided in an embodiment. The computer program product includes a non-transitory computer-readable medium having a variety of executable portions therein. In some embodiments, the computer program product receives loan information. The computer program product can also determine a first and second PAI amount based, at least in part, on the loan information. Then, the computer program product determines the interest rate by iterating through constants associated with a plurality of interest rates.

In a still further embodiment of the invention, a mortgage interest rate determination apparatus is provided. The apparatus includes a computing device processor and a mortgage interest rate determination application for operation on the computing device processor. In some embodiments, the application is configured to receive loan information including the original balance, loan term, first remaining balance, and second remaining balance. Using the computing device processor, the apparatus determines a first PAI amount and a second PAI amount, compares the first PAI amount to the second PAID amount, and determines the interest rate.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, wherein:

FIG. 1 provides a flow chart illustrating a computer-implemented method of identifying an interest rate, in accordance with one embodiment of the present invention;

FIG. 2 provides a flow chart of a computer-implemented method of providing mortgage refinancing, in accordance with one embodiment of the present invention; and

FIG. 3 provides a block schematic of a mortgage interest rate identification system, in accordance with one embodiment of the present invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

It should be understood that terms like “bank,” “financial institution,” and “institution” are used herein in their broadest sense. Institutions, organizations, or even individuals that process financial transactions are widely varied in their organization and structure. Terms like “financial institution” are intended to encompass all such possibilities, including but not limited to banks, finance companies, stock brokerages, credit unions, savings and loans, mortgage companies, insurance companies, and/or the like. Additionally, disclosed embodiments may suggest or illustrate the use of agencies or contractors external to the financial institution to perform some of the calculations, data delivery services, and/or authentication services. These illustrations are examples only, and an institution or business can implement the entire invention on their own computer systems or even a single work station if appropriate databases are present and can be accessed.

At a high level, a computer-implemented method of identifying an interest rate for a mortgage is provided. This method solves for the interest rate without knowing the combined principle and interest (PAI) payment. Instead, the computer-implemented method solves for the interest rate using the original principle amount, the loan term, and two consecutive principle amounts. The computer-implemented method utilizes a constant equal to the PAI payment for a predetermined amount, interest rate, and loan term. In an exemplary embodiment, the constant is selected from a table having a plurality of constants equal to the PAI payments to amortize $1 over a range of interest rates and loan terms. The computer-implemented method allows a bank to identify the interest rate on a mortgage based on information received from a credit bureau. In one embodiment, the interest rate determined is the exact interest rate of the mortgage.

A mortgage is a loan to purchase property. The mortgage typically includes a loan term, an interest rate, and equal periodic principle and interest (PAI) payments. Each PAI payment includes a portion that goes to paying down the principle and portion that pays the interest on the loan. As the amount of principle owed decreases over time, the interest owed on the remaining principle decreases and the portion of each payment going towards the principle increases. In this manner, the PAI payments remain equal over the loan term but the proportion of the PAI payment going to the principle compared to the interest changes. Individuals and corporate entities holding mortgages often have to pay additional fees, such as taxes and insurance, into escrow accounts. For this reason, the total periodic payment often includes the PAI payment as well as escrow funds.

While the examples provided in this disclosure are related to mortgages, it should be understood that the computer-implemented methods, apparatuses, and computer program products described herein can be used for any type of loan where the lender collects escrow or holdbacks for the benefit of the borrower. For example, the computer-implemented method described herein can be used to determine the interest rate for car loans having escrow payments.

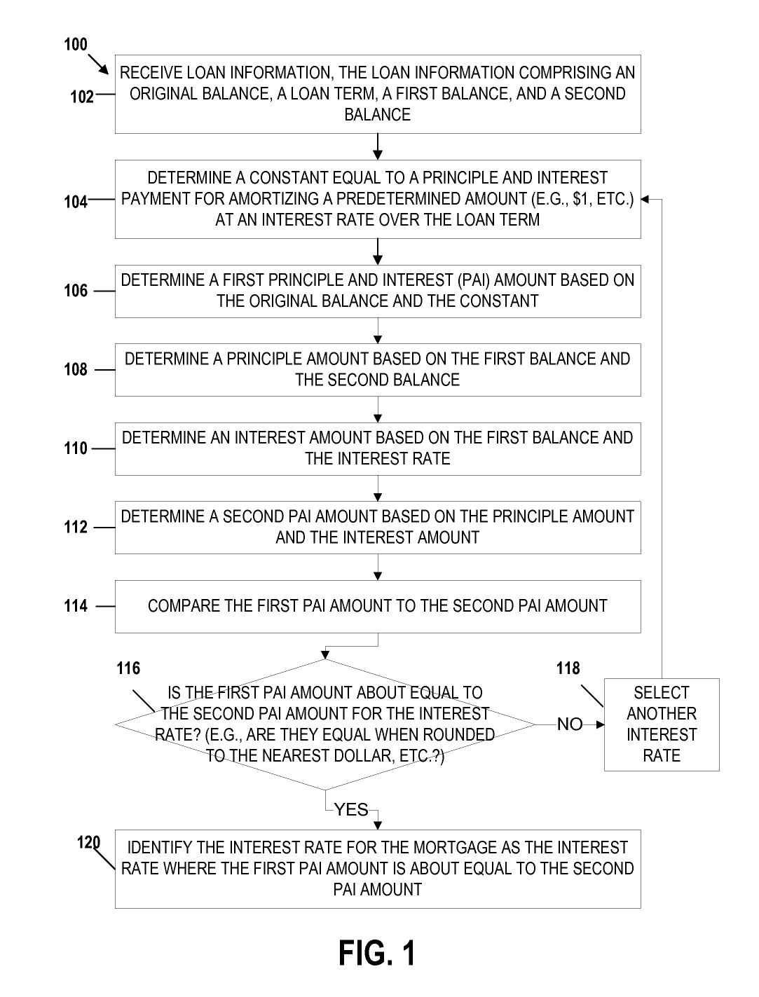

FIG. 1 provides a flow chart of a computer-implemented method of identifying a mortgage interest rate 100, in accordance with one embodiment of the present invention. In one embodiment, the computer-implemented method receives loan information 102, such as an original balance, a loan term, a first remaining balance, and a second remaining balance. In an embodiment, the first remaining balance and the second remaining balance are consecutive. The mortgage information may be for individuals or corporate entities. For example, a husband and wife may have a thirty year home mortgage that had an original balance of $100,000 and two consecutive balances of $95,204 and $95,064. In another example, a corporation may have a fifteen year commercial mortgage that had an original balance of $2,000,000 and two consecutive balances of $1,500,000 and $1,450,000. It should be understood that loan information can be received for a fixed rate mortgage on any type of property. The loan information can be received from a financial institution, from the mortgage holder, from a creditor, or from a credit bureau. In an exemplary embodiment, the loan information is received over a network. It should be understood however that the loan information may be received in any manner that allows a computing device processor to utilize the information.

Turning now to block 104, the computer-implemented method determines a constant equal to a PAI payment for amortizing a predetermined amount at an interest rate and loan term 104. In an exemplary embodiment, the computer-implemented determines a plurality of constants equal to the PAI payments for amortizing $1 at a plurality of interest rates for the loan term received in block 102. For example, the PAI payment to amortize $1 at 5% interest over a 30 year loan term with monthly payments is 0.005368216. The constants discussed herein will use nine digits after the decimal point but it should be understood that more or fewer digits can be used, so long as sufficient precision is present for calculating a first PAI payment. The computer-implemented method may determine the PAI payment to amortize $1 at every interest rate from 0.125% up to 20% at 0.125% intervals. Intervals of 0.125% are discussed because the majority of mortgages have interest rates that are set at that interval, but any interval may be used. For example, interest rates may be calculated based on intervals of 0.0625%, 0.1%, or 0.05%. It should be understood that the predetermined amount may also vary. For example, the predetermined amount may be $0.1, $10, or $100. In one example, the predetermined amount is $10 and the constants equal the PAI amount for amortizing $10 for a plurality of interest rates and loan terms.

Additionally, even though the examples discussed herein are in U.S. dollars, the computer-implemented method can determine the interest rates for loans in any currency. The loan information can be received in any currency and the constants can be calculated based on any currency. For example, the interest rate for a mortgage based on Euros can be calculated using constants determined by the amount to amortize a predetermined amount of Euros for a predetermined time and at a predetermined interest rate. Nothing in this application limits the methods, apparatuses, and computer program products to U.S. dollars.

In an exemplary embodiment, the constants are included in a table. The table may be a database or spreadsheet that can be called up when the computer-implemented method is evaluating the loan information. In one embodiment, constants for all interest rates and loan terms are included in a single table. In another embodiment, multiple tables are provided based on different loan terms, each table having the constants for the various interest rates over the loan term. For example, the table may include the constant equal to amortizing $1 at 5% over 30 years, but it may also include the constants equal to amortizing $1 at 4.875% and 5.125% over 30 years.

Turning now to block 106, the computer-implemented method determines a first PAI amount. In an embodiment, the computer-implemented method determines the first PAI amount by multiplying the original balance by the constant. In one example, the constant is the PAI amount for amortizing $1 over an interest rate and the loan term. When the system multiplies the constant by the original balance of the mortgage, the first PAI amount is determined based on the selected interest rate. For example, the first PAI amount for a mortgage having an original balance of $100,000, a loan term of 30 years, and an interest rate of 5%=100,000*0.005368216, or $536.82. This first PAI amount would be the amount the mortgage holder would have to pay on a monthly basis in principle and interest to amortize the $100,000 over 30 years at 5% interest. If the computer-implemented method selects a predetermined amount different from $1, the system can modify the original balance based on the predetermined amount (e.g., if the constant is based on a PAI for $10, the original balance can be divided by 10 to determine the first PAI amount for the original balance at the interest rate). The computer-implemented method will use the first PAI amount to determine whether the interest rate from which the first PAI amount is calculated is the interest for the mortgage. The computer-implemented method does so by comparing the first PAI amount to a second PAI amount and determining if they are about equal.

In block 108, the computer-implemented method determines a principle amount for the second PAI amount. In an embodiment, the principle amount is determined by subtracting the second remaining balance from the first remaining balance. In some embodiments, the first and second remaining balances are principle amounts remaining after payments have been made. In another embodiment, the first remaining balance is the original balance and the second remaining balance is the principle remaining after the first payment has been made. Because the balances are consecutive, the difference in the balances is equal to the amount paid towards the principle for the first payment. For example, the first remaining balance may be $95,204 and the second remaining balance may be $95,064. By subtracting the second remaining balance from the first remaining balance, the principle amount for the first payment was determined to be $95,204−$95,064, or $140 dollars. The computer-implemented method is capable of working with principle amounts rounded to the nearest dollar.

In block 110, the computer-implemented method determines an interest amount for the second PAI payment. In an embodiment, the interest amount is determined by multiplying the first remaining balance and the interest rate. In some embodiments, the interest rate is converted from an annual interest rate into an interest rate based on the periodic payment. For example, a 5% annual interest rate can be converted into a monthly interest rate, which is the period by which the mortgage is paid, by dividing 5% by 12. One of skill in the art would also know to convert a percentage into a decimal number by dividing by 100. In the ongoing example where the original balance was $100,000, the loan term was 30 years, the first remaining balance was $95,204 and the second remaining balance was $95,064, the computer-implemented method could determine the interest amount by multiplying the first remaining balance ($95,204) by 5% interest converted into a monthly interest rate and a decimal number (5/(12*100)). Thus, the interest for the first payment based on 5% interest would be $95,204*(5/(12*100), or $396.68.

In block 112, the computer-implemented method adds the principle amount and the interest amount calculated in blocks 108 and 110 together to get a second PAI amount based on the interest rate. In the example discussed above, the principle amount of $140 and the interest amount of $396.68 are added together to equal $536.68.

In block 114, the computer-implemented method compares the first PAI amount to the second PAI amount for the interest rate. In the example disclosed above, the first PAI amount was equal to $536.82 and the second PAI amount was equal to $536.68, for an original balance of $100,000, a loan term of 30 years, and a 5% interest rate. The computer-implemented method can compare the first PAI amount to the second PAI amount for every interest rate available for the loan term, or can iterate through the interest rates until the first PAI amount is about equal to the second PAI amount. Table 1 provides an example of the computer-implemented method using different interest rates.

TABLE 1
Comparison of First PAI Amount and Second PAI Amount for
different interest rates when the mortgage information
includes a $100,000 original balance, a 30 year loan term
with monthly payments, a first remaining balance of $95,204,
and a second remaining balance of $95,064

| | Constant to | | |
|---|---|---|---|
| | amortize $1 at | | |
| Interest | the interest rate | | |
| Rate | over 30 years | First PAI Amount | Second PAI Amount |
| 4.875% | 0.005292082 | 100000*0.005292082 = | (95204 − 95064) + |
| | | $529.21 | (95204*(4.875/ |
| | | | (12*100) = $526.77 |
| 5.000% | 0.005368216 | 100000*0.005368216 = | (95204 − 95064) + |
| | | $536.82 | (95204*(5/ |
| | | | (12*100) = $536.68 |
| 5.125% | 0.005444870 | 100000*0.005444870 = | (95204 − 95064) + |
| | | $544.49 | (95204*(5.125/ |
| | | | (12*100) = $546.60 |

In block 116, the computer-implemented method determines whether the first PAI amount is about equal to the second PAI amount. In an embodiment, “about equal” means equal when rounded to the nearest dollar. For example, in Table 1 the first PAI amount and second PAI amount are both equal to $537 when rounded to the nearest dollar for a 5% interest rate, but the first PAI and second PAI amounts differ when rounded for the 4.875% and 5.125% interest rates. In another embodiment, “about equal” means that the first PAI amount and the second PAI amount are the closest for all of the interest rates evaluated. In a still further embodiment, “about equal” means within a predetermined amount of one another. For example, “about equal” may mean that the first PAI amount and the second PAI amount are within $1.00 of one another. The meaning of “about equal” can also be a combination of the aforementioned possibilities. For example, “about equal” may mean equal when rounded but if none of the first PAI and second PAI amounts are equal when rounded for all interest rates considered, then the computer-implemented method will evaluate the first PAI and second PAI amounts to determine which are closest to one another. In another example, “about equal” may mean that the first PAI amount and second PAI amount are within a range of $1.00, but if the range of $1.00 results in more than one interest rate then the range can be narrowed to $0.50, etc. It should be understood that the amounts and ranges are merely examples, and that any combination of amounts and ranges may be used to iteratively eliminate interest rates, determine if the first PAI amount and second PAI amount are about equal to one another, and identify the interest rate.

In block 118, the computer-implemented method selects another interest rate for the comparison if the first PAI amount and second PAI amount are not about equal based on the previously tested interest rate. In one embodiment, the computer-implemented method iterates through the interest rates until the first PAI amount and second PAI amount are about equal. In another embodiment, the computer-implemented method iterates through all of the interest rates and then evaluates the first PAI amounts and the second PAI amounts to determine the interest rate after performing the calculations.

In block 120, the computer-implemented method identifies the interest rate for the mortgage when the first PAI amount and second PAI amount are about equal. Based on the comparison, the system determines the interest rate on the mortgage without being provided the principle and interest amount. It is not necessary to know the escrow amount or even whether escrow is included in the total payment. If the computer-implemented method receives information on the initial principle balance, the loan term, and two consecutive principle balances the system is able to determine, by means of a computing device processor, the interest rate on the mortgage. The interest rate will be more precise than the models used previously so long as certain use cases, such as loan modifications, prepayments, missed payments, and delinquencies, are not present.

The flow chart of FIG. 1 illustrates general principles and embodiments of the system and computer-implemented method of identifying a mortgage interest rate. The examples included above are not limiting and as will be discussed in greater detail later additional steps and or features may be included in the systems and computer-implemented methods. Also, the steps described above may be performed in any order. For example, the second PAI amount may be calculated before the first PAI amount while still being consistent with the current disclosure.

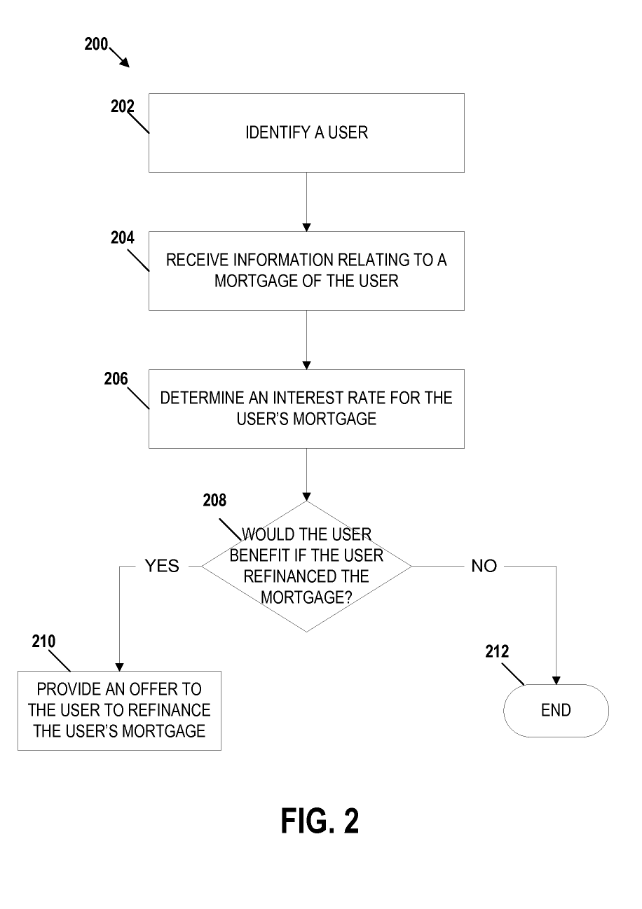

FIG. 2 provides a flow chart of a computer-implemented method of providing mortgage refinancing 200, in accordance with one embodiment of the present invention. In one embodiment, the computer-implemented method includes identifying a user, receiving information relating to a mortgage of the user, determining an interest rate for the user's mortgage, determining if the user would save money if the user refinanced the mortgage, and providing an offer to the user to refinance the user's mortgage. The computer-implemented method identifies and solicits users that would benefit from refinancing their mortgage, thereby saving the user money and developing new relationships for mortgage providers.

In an embodiment, the computer-implemented method identifies a user having a mortgage 202. In an exemplary embodiment, the computer-implemented method identifies the user from a credit bureau. For example, the system may identify a user that initiated or refinanced a mortgage during a specific period in time, such as during a year when mortgage rates were higher than currently offered. In another example, the system may identify a user based on the user's credit score, age, current principle owed, mortgage holder, or other information available through the credit bureau. In an exemplary embodiment, the system identifies users that would both benefit from refinancing and are appropriate candidates for refinancing based on credit score or other information.

In an embodiment, the computer-implemented method receives information relating to the mortgage of the user 204. As discussed previously, the computer-implemented method may receive the information in a variety of ways, such as wirelessly or over a wired network. The information includes the user's original mortgage balance, the loan term, and two consecutive balances. The information can further include contact information, the user's credit score, the user's payment history, the type of mortgage (e.g., adjustable rate, interest only, fixed, etc.) and information relating to whether the user is prepaying the mortgage. A variety of information relating to a user's finances is available from the credit bureaus and other financial institutions. The system may receive any or all of this information for use in the current computer-implemented method. As discussed previously, the computer-implemented method does not require the principle and interest amount or total payment in order to determine the user's interest rate.

In some embodiments, the computer-implemented method includes determining an interest rate for the mortgage 206. The computer-implemented method may determine the interest rate as previously described by iteratively calculating first PAI and second PAI amounts until the comparison of the amounts allows the system to determine the interest rate of the mortgage. In an embodiment, the computer-implemented method eliminates users that have missed payments or that have adjustable rate mortgages.

In an embodiment, the computer-implemented method includes evaluating whether the user has prepaid on the mortgage. The credit bureaus report the total payment required and the actual payment. Based on this information, the computer-implemented method determines whether the user prepaid and by how much. In an embodiment, the system identifies two consecutive payments when the user did not prepay and determines the user's interest rate based on those payments. In another embodiment, the system determines that the user has prepaid on every mortgage payment and modifies the process accordingly. By assuming that the prepayment amount is going towards the principle, the computer-implemented method can determine the amount that has been prepaid from the beginning. The computer-implemented method is therefore able to determine the amount that the first remaining balance and second remaining balance would have been had the user not prepaid the same amount every time. Once, the first remaining balance and second remaining balance are adjusted for the prepayment, the application is able to determine the interest in the same manner as disclosed herein.

Turning now to block 208, the computer-implemented method determines whether the user would benefit by refinancing the mortgage. In an embodiment, the computer-implemented method determines whether the user would benefit by saving money when refinancing at a lower interest rate. In another embodiment, the computer-implemented method determines whether the user would benefit by paying the mortgage off faster when refinancing. In still further embodiments, the computer-implemented method determines whether the user would build equity faster or receive tax benefits by refinancing the mortgage. In an exemplary embodiment, the computer-implemented method determines what the user's principle and interest payment is based on the user's current loan balance and interest rate, and what the user's PAI payment would be if the user refinanced based on the prevailing or applicable interest rates. Thus, the computer-implemented method is able to determine the user's interest rate and make targeted offers to users who would both benefit from and potentially qualify for refinancing.

In an embodiment, the computer-implemented method offers to refinance the user's mortgage if the user would benefit 210. The offer may be in writing, over the internet, over the phone, through the mail, or in any other manner of contacting the user. If the computer-implemented method determines that the user would not benefit from refinancing, and therefore would be unlikely to refinance, the computer-implemented method saves money by not offering the user a refinancing option 212.

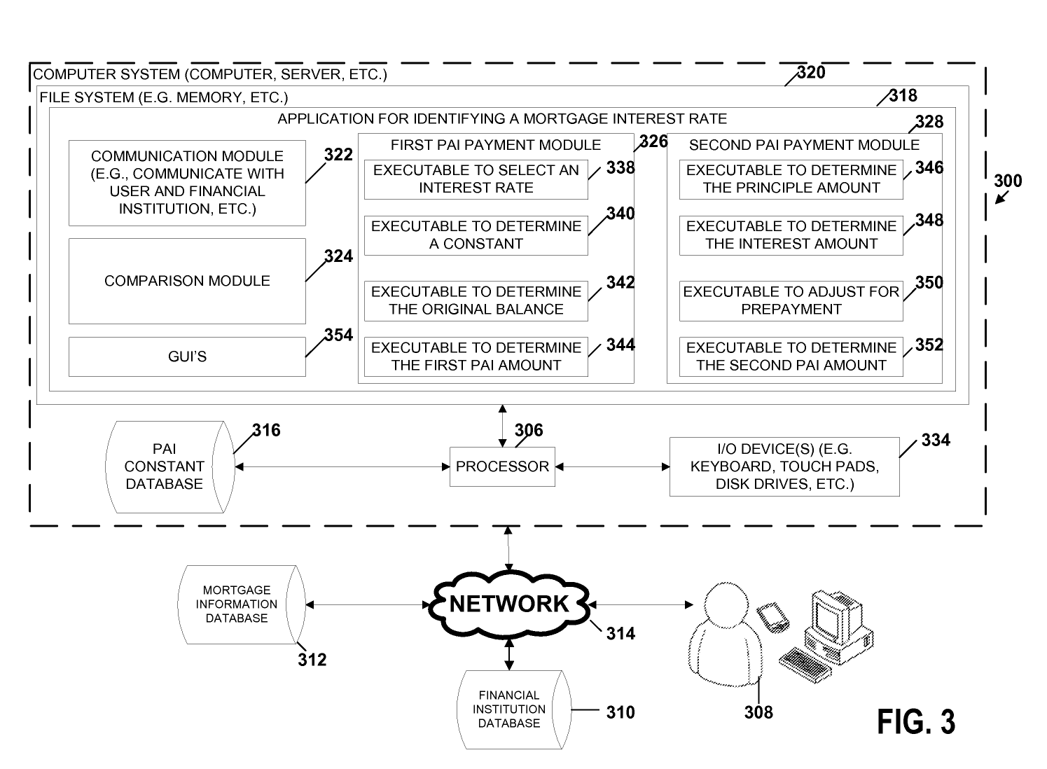

FIG. 3 is a schematic block diagram of a mortgage refinancing system 300, in accordance with an embodiment of the invention. In some embodiments, the system 300 includes a computer system such as a computer or server, etc. In an exemplary embodiment, the mortgage refinancing system is a server including a communication device 304 and a processing device 306. In some embodiments, the system interacts with a user 308, a financial institution database 310, and a mortgage information database 312 over a network 314.

The network 314 may be a global area network (GAN), such as the Internet, a wide area network (WAN), a local area network (LAN), a wifi network, a 3G or 4G network or any other type of network or combination of networks. The network 314 may provide for wireline, wireless, or a combination of wireline and wireless communication between devices on the network.

As used herein, the term “processing device” generally includes circuitry used for implementing the communication and/or logic functions of a particular system. For example, the processing device 306 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 306 may include functionality to operate one or more software programs based on computer-readable instructions thereof, which may be stored in the memory device 302.

The processing device 306 is operatively coupled to the communication device 304. The processing device 306 uses the communication device 304 to communicate with the user 308, the financial institution database 310, and/or the mortgage information database 312.

As further illustrated in FIG. 3, the mortgage refinancing system includes computer-readable instructions 320 stored in a file system, which in one embodiment includes the computer-readable instructions 320 of a mortgage interest rate identification application 318.

In the embodiment illustrated in FIG. 3 and described throughout much of this specification, the mortgage interest rate identification application 318 allows for communication between a communication module 322, a comparison module 324, a first PAI payment module 326, and a second PAI payment module 328 to send, receive, and store information related to the mortgage refinancing system, determine details relating to a loan, determine the user's interest rate, and determine whether the user should be offered refinancing.

Specifically, the communication module 322 facilitates communication between the mortgage refinancing system and the user 308. In some embodiments, the user is an employee of the financial institution that offers refinancing. In other embodiments, the user is the person that has a mortgage and would like to know whether refinancing would be beneficial to them. By using the system and computer-implemented method provided herein, the mortgage holder can determine whether refinancing is beneficial without needing to know their own interest rate. In one embodiment, the communication module 322 controls the communication devices associated with the system. For example, the communication module 322 can control I/O devices such as keyboards, screens, touchpads, etc. 334.

The communication module 322 also communicates with the mortgage information database 312, such as at a credit bureau, to receive mortgage information. In an embodiment, the communication module 322 receives the original mortgage amount, the loan term, at least two consecutive balances, information on the type of mortgage, and information on whether the mortgage has ever been delinquent or prepaid.

In some embodiments, the first PAI payment module 326 determines the first PAI payment based on the original loan balance and a constant related to an interest rate. In some embodiments, the permission module includes at least one of an executable to select an interest rate 338, an executable to determine a constant 340, an executable to determine the original balance 342, and an executable to determine the first PAI amount 344. The executables can be subroutines available to the mortgage interest rate identification application and called up when input is received or output is needed.

In some embodiments, the executable to select an interest rate 338 determines an interest rate to begin the process. In an embodiment, the interest rate is selected based on interest rates for mortgages. In an exemplary embodiment, the initial interest rate is selected based on the interest rates that were being offered when the mortgage originated. In another embodiment, the interest rate is selected randomly. It should be understood that the interest rate can be selected in any manner, and that it is merely a starting point from which the process will continue to iterate through interest rates until the user's interest rate is identified.

In some embodiments, the executable to determine a constant 340 retrieves a constant from a PAI constant database 316 for the interest rate selected by the executable to select an interest rate 338. In another embodiment, the executable to determine a constant 340 generates the constant every time and does not call up the PAI constant database 316. In one embodiment, the PAI constant database 316 includes a single table having the PAI constants for all interest rates and loan terms relevant to mortgages. In another embodiment, the PAI constant database 316 includes multiple tables distinguished by the loan term, each table having the PAI constants for all interest rates at that loan term.

In an embodiment, the executable to determine the original balance 342 receives the original balance from the mortgage information database 312 through the communication module 322. For example, the executable to determine the original balance 342 may receive the balance from a mortgage information database at a credit bureau. In another embodiment, the executable to determine the original balance receives the original balance directly from the user 308. The user may upload the original loan balance to a website, for example, along with the loan term and two consecutive balances to determine if refinancing would be beneficial.

In still further embodiments, the executable to determine the first PAI amount 344 multiplies the constant by the original balance to determine the PAI payment amount. In another embodiment, the executable to determine the first PAI amount 344 provides the first PAI amount to the comparison module 324.

In some embodiments, the second PAI payment module 328 determines the second PAI payment amount for an interest rate based on the first remaining balance and the second remaining balance. In some embodiments, the second PAI payment module includes at least one of an executable to determine the principle amount 346, an executable to determine the interest amount 348, an executable to adjust for prepayment 350, and an executable to determine the second PAI amount 352. The executables can be subroutines available to the mortgage interest rate identification application and called up when input is received or output is needed.

In an embodiment, the executable to determine the principle amount 346 receives a first remaining balance and a second remaining balance from the mortgage information database 312. The executable to determine the principle amount 346 confirms that the first remaining balance and the second remaining balance are consecutive and that the principle was not prepaid for either payment. For example, the total payment required and the total payment paid may be compared to determine whether the mortgage was prepaid. If the balances are consecutive and not prepaid, then the executable to determine the principle amount 346 may determine the principle by subtracting the second remaining balance from the first remaining balance. The absolute difference between the first remaining balance and the second remaining balance is the amount of the principle paid during the payment period when the first remaining balance was paid.

In some embodiments, the executable to determine the interest amount 348 receives the interest rate from the executable to select an interest rate 338 and converts the annual percentage rate into a monthly decimal rate. It should be understood that the conversion to the payment period can be performed in any manner. If for, example, the mortgage is paid on a semiannual basis, the annual percentage rate can be converted into a semiannual decimal rate for determining the interest amount. Once the interest rate is converted into the same units as the pay period the interest rate is multiplied by the first remaining balance. The product of the first remaining balance and the interest rate is the amount of interest owed on that principle balance for that payment period.

In further embodiments, the executable to adjust for prepayment 350 determines whether the user ever prepaid the mortgage. If the user prepaid the mortgage in the same amount for all of the payment periods, the computer-implemented method can be modified to adjust for the prepayment. The amount prepaid can be determined, and the principle amount determined after controlling for the prepayment amount.

In an embodiment, the executable to determine the second PAI amount 352 sums the principle amount and the interest amount. The resulting sum is the second PAI amount for the interest rate used in the determination. The executable to determine the second PAI amount 352 provides the second PAI amount to the comparison module 324 for use in the computer-implemented method.

In some embodiments, the comparison module 324 compares the results of the first PAI payment module and the second PAI payment module to determine the user's interest rate. As discussed, the comparison can be performed iteratively for each interest rate in the PAI constant database until the interest rate is determined, or the comparison can be performed for all of the constants and then the interest rate determined based on the results.

In another embodiment, the comparison module 324 also compares the user's mortgage information, including the interest rate determined by the computer-implemented method, to the current mortgage interest rates being offered by mortgage providers. If the comparison module 324 determines that the user would benefit from refinancing the mortgage, the communication module 322 can provide that information to the user 308.

The mortgage interest rate identification application 318 also includes Graphical User Interfaces (GUI's) 354, in some embodiments. The GUI's 354 assist in communication between the user 308 and the system. Multiple GUI's 354 can be available for the communication module 322, the comparison module 324, the first PAI payment module 326, and the second PAI payment module 328. GUI's 354 can also be provided that assist the user in utilizing the I/O devices 334, or any other feature of the mortgage refinancing system 300.

The computer-implemented methods, computer program products, and apparatuses described herein provide a technical effect to solve a technical problem. At a minimum, the computer-implemented methods, computer program products, and apparatuses described herein reduce the processing load for mortgage systems by more accurately determining the interest rate.

It is understood that the servers, systems, and devices described herein illustrate one embodiment of the invention. It is further understood that one or more of the servers, systems, and devices can be combined in other embodiments and still function in the same or similar way as the embodiments described herein.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” For example, various embodiments may take the form of web-implemented computer software. Furthermore, embodiments of the present invention may take the form of a computer program product on a computer-readable medium having computer-executable program code embodied in the medium.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments may be configured without departing from the scope and spirit of the invention. Therefore, it is to be understood that, within the scope of the appended claims, the invention may be practiced other than as specifically described herein.

What is claimed is:

1. A computer-implemented method of determining an interest rate for a mortgage loan, the method comprising:
receiving loan information, the loan information comprising an original balance, a loan term, a first remaining balance, and a subsequent second remaining balance;
determining, via a computing device processor, a first principle and interest (PAI) amount based on the original balance and the loan term for a plurality of interest rates;
determining, via the computing device processor, a second PAI amount based on the first remaining balance, the second remaining balance, and the plurality of interest rates;
comparing the first PAI amount to the second PAI amount for the plurality of interest rates; and
identifying the interest rate-based on the comparison of the first PAI amount to the second PAI.

2. The computer-implemented method of claim 1, wherein the first remaining balance and second remaining balance are consecutive.

3. The computer-implemented method of claim 1, wherein the determining the first PAI amount comprises:
determining, via a computing device processor, a constant equal to a periodic payment to amortize a selected monetary amount at the plurality of interest rates for the loan term; and
multiplying the constant against the original balance to determine the first PAI amount for the plurality of interest rates.

4. The computer-implemented method of claim 3, wherein determining comprises determining a constant equal to a periodic payment to amortize a selected monetary amount of $1 at the plurality of interest rates for the loan term.

5. The computer-implemented method of claim 3, the method further comprising:
providing a table comprising the constants for the plurality of interest rates and the loan term.

6. The computer-implemented method of claim 1, wherein the determining the second PAI amount comprises:
determining, via a computing device processor, the principle amount by determining an absolute difference between the first remaining balance and the second remaining balance;
determining, via a computing device processor, an interest amount by determining a product of the first remaining balance and the plurality of interest rates; and
determining, via a computing device processor, a sum of the principle amount and the interest amount for the plurality of interest rates.

7. The computer-implemented method of claim 1, wherein the comparing the first PAI amount to the second PAI amount for the plurality of interest rates comprises:
iterating through the first PAI amount and second PAI amount for the plurality of interest rates.

8. The computer-implemented method of claim 1, wherein identifying the interest rate for the mortgage based on the comparison of the first PAI amount to the second PAI comprises:
selecting the interest rate from the plurality of interest rates that results in the first PAI amount and second PAI amount being about equal.

9. The computer-implemented method of claim 8, wherein about equal means the first PAI amount and second PAI amount are equal when rounded to the nearest monetary whole number.

10. The computer-implemented method of claim 1, wherein the original balance, the first remaining balance, and the second remaining balance are rounded to the nearest monetary whole number.

11. The computer-implemented method of claim 1, further comprising:
selecting the plurality of interest rates from interest rates offered for mortgages.

12. A computer program product for providing a mortgage refinancing product, the computer program product comprising:
a non-transitory computer-readable medium comprising:
an executable portion for causing a computer to receive loan information, the loan information comprising an original balance, a loan term, a first remaining balance, and a subsequent second remaining balance;
an executable portion for causing a computer to determine a first PAI amount based on the original balance and the loan term for a plurality of interest rates;
an executable portion for causing a computer to determine a second PAI amount based on the first remaining balance and second remaining balance for a plurality of interest rates;
an executable portion for causing a computer to compare the first PAI amount with the second PAI amount for the plurality of interest rates; and
an executable portion for causing a computer to determine the interest rate based on the comparison of the first PAI amount to the second PAI amount.

13. The computer program product of claim 12, wherein the non-transitory computer readable medium further comprises:
an executable portion for causing a computer to determine if a mortgage holder would benefit from refinancing based on the identified interest rate; and
an executable portion for causing a computer to offer refinancing to the mortgage holder if the user would benefit from refinancing.

14. The computer program product of claim 12, further comprising an executable portion for causing a computer to determine if the user has prepaid the original balance.

15. The computer program product of claim 12, further comprising an executable portion for causing a computer to adjust the second PAI amount if the mortgage holder prepaid the original balance.

16. The computer program product of claim 12, wherein the executable portion for causing a computer to determine the first PAI amount comprises:
an executable portion for causing a computer to determine a constant equal to a periodic payment to amortize a selected monetary amount at the plurality of interest rates for the loan term; and
an executable portion for causing a computer to determine the product of the original balance and the constant for the plurality of interest rates.

17. The computer program product of claim 12, wherein the loan information is received from a credit bureau.

18. The computer program product of claim 12, wherein the loan information does not include the PAI amount.

19. The computer program product of claim 12, wherein the original balance, the first remaining balance, and the second remaining balance are rounded to the nearest monetary whole number.

20. The computer program product of claim 12, wherein the loan information indicates a fixed rate mortgage.

21. The computer program product of claim 12, wherein executable portion for causing a computer to compare the first PAI amount with the second PAI amount for the plurality of interest rate comprises an executable portion for iterating through the plurality of interest rates until the first PAI amount is about equal to the second PAI amount.

22. A mortgage interest rate determination apparatus comprising:
a computing device processor; and
a mortgage interest rate determination application for operation on said computing device processor, said application configured to:
receive loan information, the loan information comprising an original balance, a loan term, a first remaining balance, and a subsequent second remaining balance;
determine, via the computing device processor, a first principle and interest (PAI) amount based on the original balance and the loan term for a plurality of interest rates;
determine, via the computing device processor, a second PAI amount based on the first remaining balance, the second remaining balance, and the plurality of interest rates;
compare the first PAI amount to the second PAI amount for the plurality of interest rates; and
identify the interest rate based on the comparison of the first PAI amount to the second PAI.

23. The mortgage interest rate determination apparatus of claim 22, the application further configured to compare the interest rate to prevailing available interest rates for mortgages.

24. The mortgage interest rate determination apparatus of claim 23, the application further configured to communicate an offer to refinance if the prevailing available interest rates are less than the interest rate.

25. The mortgage interest rate determination apparatus of claim 22, the apparatus further comprising a network adapter configured to communicate with at least one of a user, a financial institution, and a credit bureau.

26. The mortgage interest rate determination apparatus of claim 22, the application further configured to iterate through the plurality of interest rates until the first PAI amount is about equal to the second PAI amount.

27. The mortgage interest rate determination apparatus of claim 26, wherein about equal means that the first PAI amount and second PAI amount are equal when rounded to the nearest whole monetary unit.

28. The mortgage interest rate determination apparatus of claim 22, the application further configured to exclude a mortgage if the loan information includes a trigger, wherein the trigger is selected from the group consisting of information indicating that the mortgage is an interest only mortgage, information indicating that the mortgage is an adjustable rate mortgage, information indicating that the mortgage is a delinquent mortgage, information indicating that the mortgage is a mortgage with a frequently variable monthly payment amount, and information indicating that the mortgage is a prepaid mortgage.

29. The mortgage interest rate determination apparatus of claim 22, wherein the first PAI amount is determined by multiplying the original balance by a constant equal to the amount to amortize a monetary amount at an interest rate.

30. The mortgage interest rate determination apparatus of claim 22, wherein the second PAI amount is determined by:
determining a principle amount as an absolute difference between the first remaining balance and the second remaining balance;
determining an interest amount as a product of the first remaining balance and the interest rate; and
determining the second PAI amount as a sum of the principle amount and the interest amount.
